(19) United States
(12) Patent Application Publication
(10) Pub. No.: US 2012/0213936 A1
(43) Pub. Date: Aug. 23, 2012

(54) COATING APPARATUS AND METHOD FOR REPLACING LIQUID MATERIAL THEREOF AND CLEANING METHOD THEREOF

(75) Inventors: Chi Chin Chiang, Shenzhen (CN); Chengming He, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/125,155

(22) PCT Filed: Mar. 24, 2011
(86) PCT No.: PCT/CN2011/072093

§ 371 Date: Apr. 20, 2011

(30) Foreign Application Priority Data
Feb. 18, 2011 (CN) 201110041335.4

(51) Int. Cl. B05C 11/00; B08B 13/00; B08B 9/08; B05D 1/00; B08B 9/027

(52) U.S. Cl. 427/401; 118/704; 118/75; 134/18

(57) ABSTRACT

The present invention provides a coating apparatus, a method for replacing a liquid material thereof and a cleaning method thereof. The coating apparatus comprises at least one tank, a draining device, a cleaning solution valve switch, a second liquid material valve switch and a control unit. The method comprises the following steps: utilizing the control unit to control the draining device for draining the first liquid material from the tank; utilizing the control unit to control the cleaning solution valve switch for introducing the cleaning solution into the tank; utilizing the control unit to control the draining device for draining the cleaning solution from the tank; and utilizing the control unit to control the second liquid material valve switch for introducing a second liquid material into the tank. The present invention can prevent the man-made errors and reduce the maintenance labor and time.

### FIELD OF THE INVENTION

The present invention relates to a coating apparatus, a method for replacing a liquid material thereof and a cleaning method thereof, and more particularly, to a coating apparatus, a method for replacing a liquid material thereof, and a cleaning method thereof being capable of automatically replacing the liquid material.

### BACKGROUND OF THE INVENTION

Normally, a coating apparatus is used for coating a liquid material on a surface to form a uniform film thereon. For example, in a semiconductor device fabrication, a photo-resist can be coated on a substrate (such as a wafer) to form a uniform photo-resist layer thereon.

According to various processes, the coating apparatus needs to replace various liquid materials for coating various films on the substrate. Furthermore, in order to maintain the apparatus, it is required to regularly or irregularly clean tanks, pipes or coating heads of the coating apparatus.

However, currently, the process of replacing the liquid materials of the coating apparatus or cleaning the apparatus is mostly done by a manual operation. In this case, the manual operation needs more labor and time, and operation errors are likely to occur, thereby affecting the efficiency and quality of coating process.

As a result, it is necessary to provide a coating apparatus, a method for replacing a liquid material thereof and a cleaning method thereof to solve the problems existing in the conventional technologies, as described above.

### SUMMARY OF THE INVENTION

A primary object of the present invention is to provide a coating apparatus comprising a coating device; at least one tank connected to the coating device; a draining device connected between the coating device and the tank and configured to drain a first liquid material and/or a cleaning solution; a cleaning solution valve switch disposed between a cleaning solution tank and the tank and configured to switch the introduction of the cleaning solution; a second liquid material valve switch disposed between a second liquid material tank and configured to switch the introduction of a second liquid material; and a control unit electrically connected to the cleaning solution valve switch, the draining device and the second liquid material valve switch and configured to control the cleaning solution valve switch, the draining device and the second liquid material valve switch.

Another object of the present invention is to provide a method for replacing a liquid material of a coating apparatus, wherein the coating apparatus comprises at least one tank, a draining device, a cleaning solution valve switch, a second liquid material valve switch and a control unit, and the draining device is configured to drain a first liquid material and/or a cleaning solution, and the cleaning solution valve switch is configured to switch the introduction of the cleaning solution, and the control unit is electrically connected to the cleaning solution valve switch, the draining device and the second liquid material valve switch. The method comprises the following steps: utilizing the control unit to control the draining device for draining the first liquid material from the tank; utilizing the control unit to control the cleaning solution valve switch for introducing the cleaning solution into the tank; utilizing the control unit to control the draining device for draining the cleaning solution from the tank; and utilizing the control unit to control the second liquid material valve switch for introducing a second liquid material into the tank.

A further object of the present invention is to provide a cleaning method of a coating apparatus, wherein the coating apparatus comprises at least one tank, a draining device, a cleaning solution valve switch, a second liquid material valve switch and a control unit, and the draining device is configured to drain a first liquid material and/or a cleaning solution, and the cleaning solution valve switch is configured to switch the introduction of the cleaning solution, and the control unit is electrically connected to the cleaning solution valve switch, the draining device and the second liquid material valve switch. The method comprises the following steps: utilizing the control unit to control the draining device for draining the first liquid material from the tank; utilizing the control unit to control the cleaning solution valve switch for introducing the cleaning solution into the tank; and utilizing the control unit to control the draining device for draining the cleaning solution from the tank.

In one embodiment of the present invention, the cleaning solution valve switch, the draining device and the second liquid material valve switch are controlled by the control unit according to a predetermined replacing procedure or instruction.

In one embodiment of the present invention, the at least one tank comprises a first tank and a second tank, and the coating apparatus further comprises an automatic pump electrically connected between the first tank and the second tank.

In one embodiment of the present invention, the coating apparatus further comprises a filter disposed between the first tank and the second tank.

In one embodiment of the present invention, the coating apparatus further comprises an automatic pump connected between the draining device and the coating device.

In one embodiment of the present invention, the coating apparatus further comprises a coating device, and the method further comprises the following step: utilizing the control unit to control the draining device for draining the first liquid material from the coating device after draining the first liquid material from the tank.

In one embodiment of the present invention, the method further comprises the following steps:

utilizing the control unit to control the cleaning solution valve switch for introducing the cleaning solution into the coating device and the tank after draining the cleaning solution from the tank and before introducing the second liquid material into the tank;

utilizing the control unit to control the coating device for continuously spraying the cleaning solution; and

utilizing the control unit to control the draining device for draining the cleaning solution from the coating device and the tank.

In one embodiment of the present invention, the method further comprises the following step: utilizing the control unit to control the draining device for draining the second liquid material from the tank.

In one embodiment of the present invention, the coating apparatus further comprises a coating device, and the method further comprises the following step: utilizing the control unit to control the second liquid material valve switch for introducing the second liquid material into the coating device and the tank after draining the second liquid material from the tank.

In one embodiment of the present invention, the method further comprises the following steps:

utilizing the control unit to control the coating device for continuously spraying the second liquid material during a predetermined time; and

utilizing the control unit to control the coating device for stopping the spray of the second liquid material.

In comparison with the manual replacing process of the liquid material of the conventional coating apparatus, in the present invention, the coating apparatus, the method for replacing the liquid material thereof and the cleaning method thereof can automatically replace the liquid material for preventing the man-made errors and reducing the maintenance labor and time, thereby raising the throughput of the apparatus.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a schematic diagram showing a coating apparatus according to a preferred embodiment of the present invention;

FIG. 2 is a block diagram showing automatic pumps, pneumatic valve switches and a control unit according to a preferred embodiment of the present invention;

FIG. 3 is a flow diagram showing a method for replacing the liquid material of the coating apparatus according to the preferred embodiment of the present invention; and

FIG. 4 through FIG. 14 are schematic diagrams showing the coating apparatus according to the preferred embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

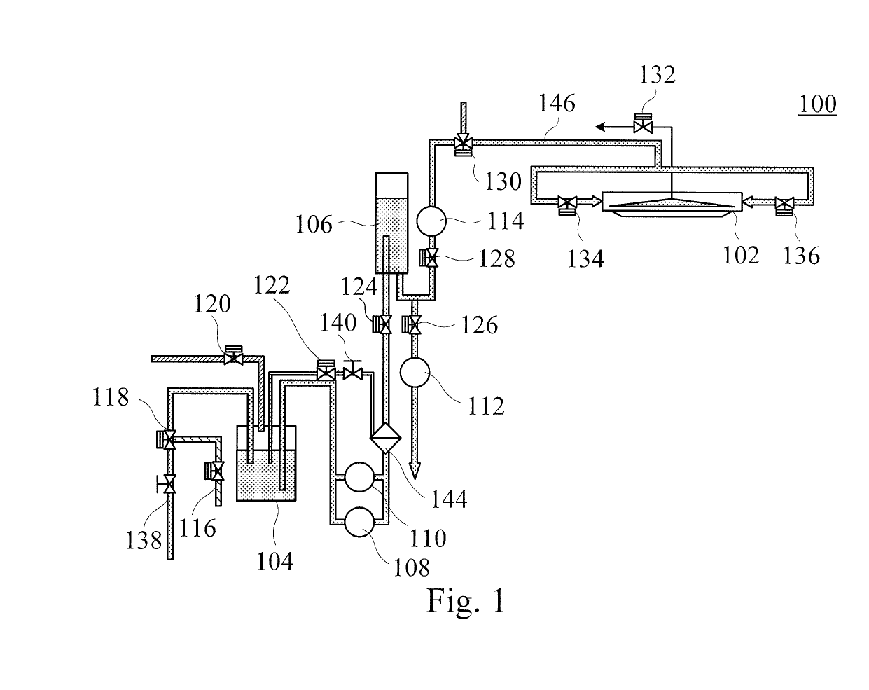

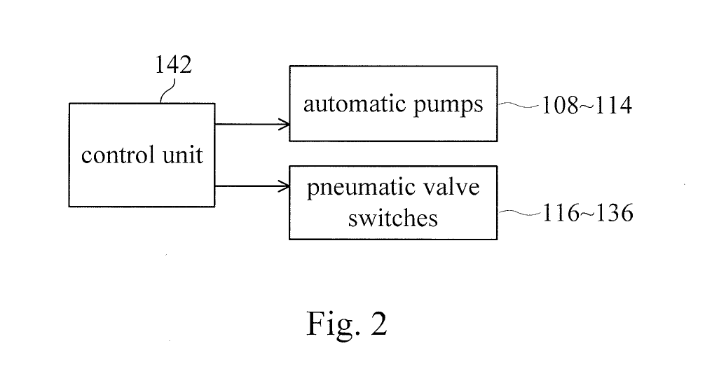

Referring to FIG. 1 and FIG. 2, FIG. 1 is a schematic diagram showing a coating apparatus according to a preferred embodiment of the present invention, and FIG. 2 is a block diagram showing automatic pumps, pneumatic valve switches and a control unit according to a preferred embodiment of the present invention. The coating apparatus 100 of the present embodiment may be configured to coat a liquid material (such as a photo-resist) on a substrate (such as a wafer or a glass substrate) to form a thin film thereon. The coating apparatus 100 may comprise a coating device 102, a first tank 104, a second tank 106, automatic pumps 108, 110, 112 and 114, pneumatic valve switches 116, 118, 120, 122, 124, 126, 128, 130, 132, 134 and 136, manual valve switches 138 and 140, a control unit 142 (referring to FIG. 2), a filter 144 and a plurality of pipes 146. The coating device 102 may be, for example, a spin coating head, a slit coating head or an inkjet printing head for forming a uniform thin film on the substrate. Referring to FIG. 1 again, the tanks 104, 106 are connected to the coating device 102 through the pipes 146 for storing liquid materials to be coated by the coating device 102. The automatic pumps 108-114 are disposed between the tanks 104, 106, and the coating device 102 for pumping the liquid materials. The pneumatic valve switches 116-136 and the manual valve switches 138-140 are disposed along the pipes 146 for selectively opening closing the pipes 146. Referring to FIG. 1 and FIG. 2 again, the control unit 142 may be, for example, a CPU, a multi-processing unit, a reduced instruction set computer (RISC), a processor comprising a pipeline, a complex instruction set computer (CISC), a digital signal processor (DSP) and the like of which is electrically connected to the automatic pumps 108-114 and the pneumatic valve switches 116-136 for controlling the automatic pumps 108-114 and the pneumatic valve switches 116-136. Referring to FIG. 1 again, the filter 144 can be disposed between the first tank 104 and the second tank 106 for filtering the liquid materials.

Referring to FIG. 1 again, the first and second automatic pumps 108 and 110 are disposed between the first tank 104 and the filter 144. The third automatic pump 112 is disposed between the second tank 106 and the coating device 102 for draining the material from the coating apparatus 100, i.e. the third automatic pump 112 can act as a draining device. The fourth automatic pump 114 is disposed between the third automatic pump 112 (draining device) and the coating device 102.

Referring to FIG. 1 again, the first pneumatic valve switch 116 is disposed between a second liquid material tank (not shown) and the second pneumatic valve switch 118, i.e. the first pneumatic valve switch 116 can act as a second liquid material valve switch. The second pneumatic valve switch 118 is disposed between the manual valve switch 138 and the first tank 104. The third pneumatic valve switch 120 is disposed between a cleaning solution tank (not shown) and the first tank 104, i.e. the third pneumatic valve switch 120 is disposed between a cleaning solution tank can act as a cleaning solution valve switch. The fourth pneumatic valve switch 122 is disposed between the first tank 104 and the filter 144. The fifth pneumatic valve switch 124 is disposed between the filter 144 and the second tank 106. The sixth pneumatic valve switch 126 is disposed between the second tank 106 and the automatic pump 112. The seventh pneumatic valve switch 128 is disposed between the sixth pneumatic valve switch 126 and the fourth automatic pump 114. The eighth pneumatic valve switch 130 is disposed between the cleaning solution tank and the coating device 102, i.e. the eighth pneumatic valve switch 130 can act as a cleaning solution valve switch. The ninth pneumatic valve switch 132 is disposed between the coating device 102 and the exterior. The tenth and eleventh pneumatic valve switches 134 and 136 are disposed between the eighth pneumatic valve switch 130 and the coating device 102. The first manual valve switch 138 is dispose between the second pneumatic valve switch 118 and a first liquid material tank (not shown). The second manual valve switch 140 is disposed between the fourth pneumatic valve switch 122 and the filter 144.

Referring to FIG. 2 again, according to a predetermined replacing procedure or instruction, the control unit 142 can control the automatic pumps 108-114 and the pneumatic valve switches 116-136 (comprising the cleaning solution valve switch, the draining device and the second liquid material valve switch), so as to allow the coating apparatus 100 to automatically implement the replacing of liquid material and the cleaning for reducing the errors of manual operation and the replacing time.

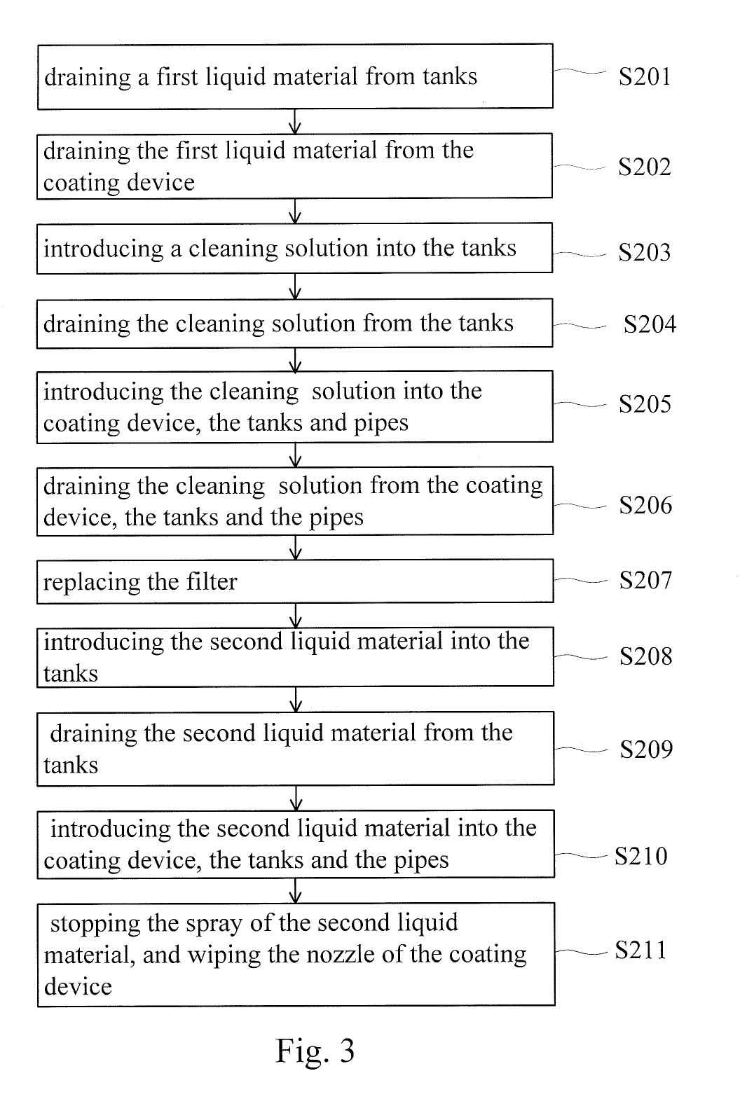

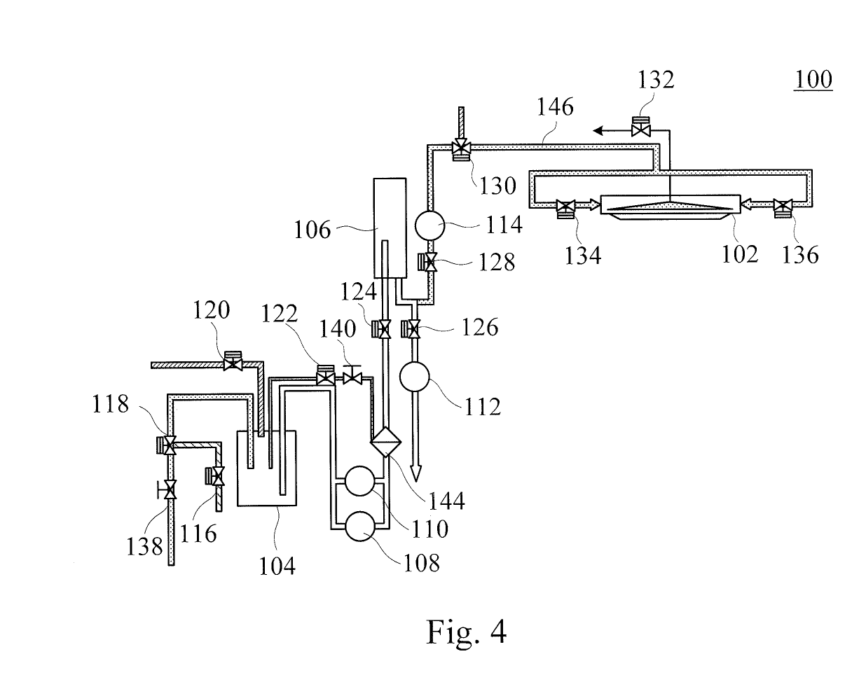

Referring to FIG. 3 through FIG. 14, FIG. 3 is a flow diagram showing a method for replacing the liquid material of the coating apparatus according to the preferred embodiment of the present invention, and FIG. 4 through FIG. 14 are schematic diagrams showing the coating apparatus according to the preferred embodiment of the present invention. Referring to FIG. 3 and FIG. 4 again, in a step S201, the control unit 142 is utilized to control the draining device (automatic pump 112) for draining the first liquid material from the tanks 104 and 106. At this time, the control unit 142 can be utilized to close the pneumatic valve switches 116, 118, 120, 122, 128, 132, 134 and 136, and to open the fifth and sixth pneumatic valve switches 124 and 126, and then to activate the automatic pumps 108, 110 and 112. Therefore, the first liquid material in the tank 104 and 106 can be drained from the coating apparatus 100 by the draining device (automatic pump 112). The first liquid material is stored in the tanks 104 and 106 before being replaced, i.e. the first liquid material is the original liquid material used by the coating apparatus 100.

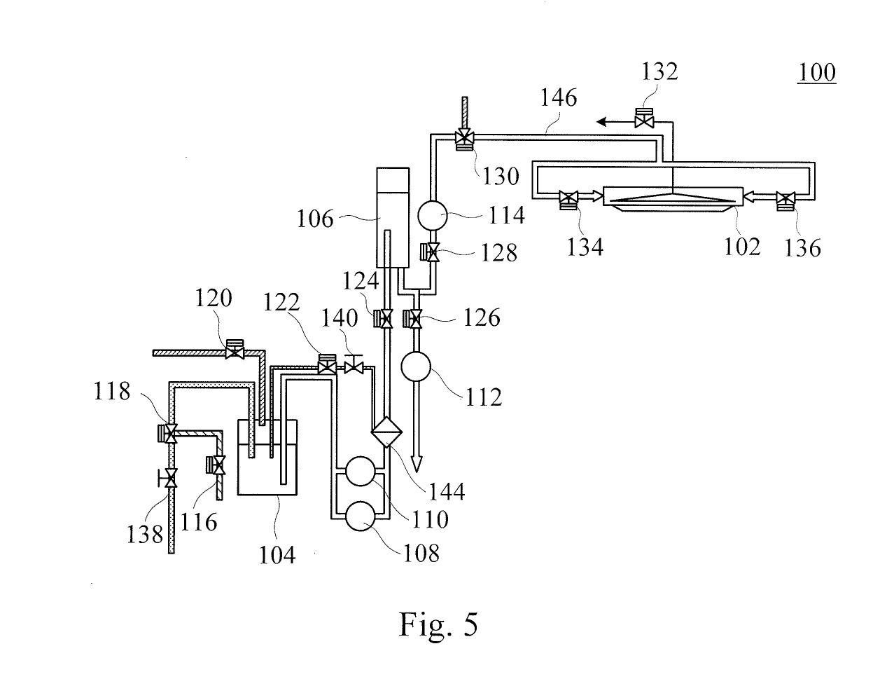

Referring to FIG. 3 and FIG. 5 again, in a step S202, the control unit 142 is utilized to control the draining device (automatic pump 112) for draining the first liquid material from the coating device 102. At this time, the control unit 142 can be utilized to close the first to fifth pneumatic valve switches 116-124 and the automatic pumps 108 and 110, and to open the sixth to eleventh pneumatic valve switches 126-136, and then to activate the third automatic pumps 112, so as to drain the first liquid material from the coating device 102.

In one embodiment, the above-mentioned steps S201 and S202 can be implemented at the same time. That is, the control unit 142 can be utilized to control the draining device (automatic pump 112) for simultaneously draining the first liquid material from the tanks 104, 106, and the coating device 102. However, in other embodiments, the step S202 can be omitted, and only the step S201 is implemented but not limited to the above description.

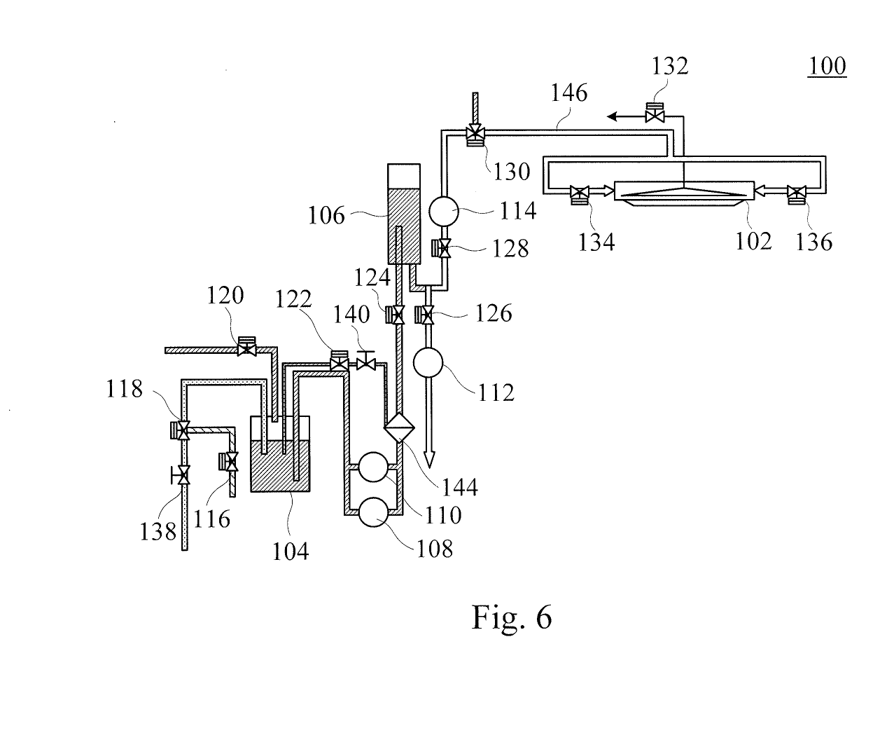

Referring to FIG. 3 and FIG. 6 again, in a step S203, the control unit 142 is utilized to control the cleaning solution valve switch (the pneumatic valve switch 120) for introducing the cleaning solution into the tanks 104 and 106, so as to clean the tanks 104 and 106. At this time, the control unit 142 can be utilized to close the pneumatic valve switches 116, 118, 126, 128, 130, 132, 134 and 136 and the automatic pumps 112 and 114, and to open the third to fifth pneumatic valve switches 120-124, and then to activate the automatic pumps 108 and 110, so as to introduce the cleaning solution into the tanks 104 and 106.

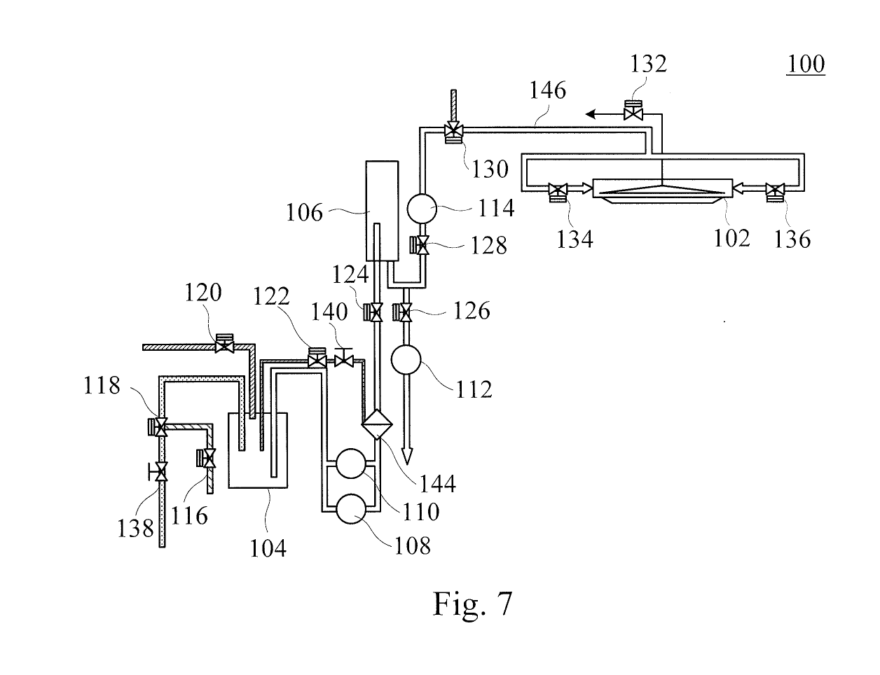

Referring to FIG. 3 and FIG. 7 again, in a step S204, the control unit 142 is utilized to control the draining device (automatic pump 112) for draining the cleaning solution from the tanks 104 and 106. At this time, the control unit 142 can be utilized to close the pneumatic valve switches 116, 118, 120, 122, 128, 130, 132, 134 and 136 and the automatic pump 114, and to open the fifth and sixth pneumatic valve switches 124 and 126, and then to activate the automatic pumps 108, 110 and 112, so as to drain the cleaning solution from the tanks 104 and 106.

It is worth mentioning that the clean process of the above-mentioned steps S203 and S204 can implemented for one time or several times to ensure the cleaning of the tanks 104 and 106.

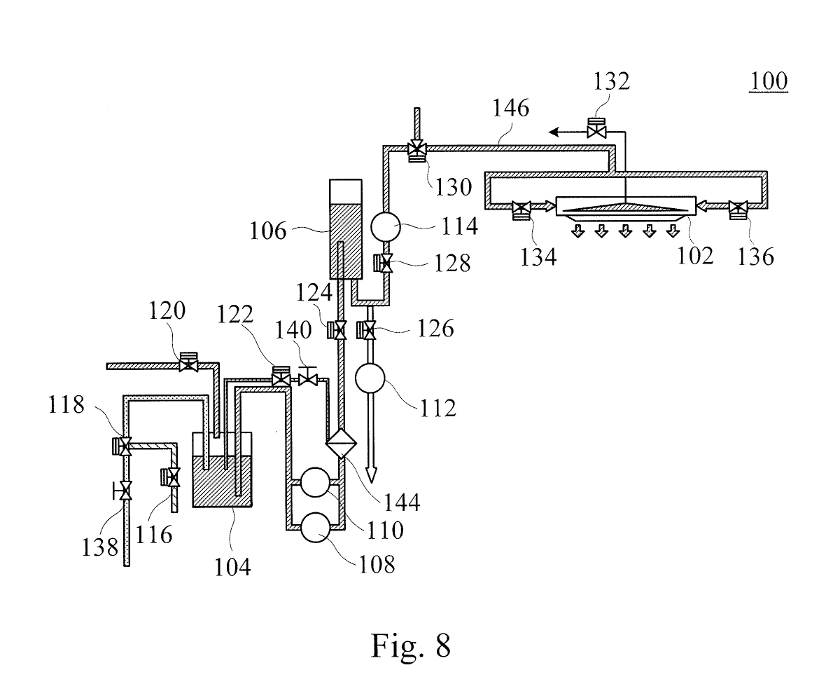

Referring to FIG. 3 and FIG. 8 again, in a step S205, the control unit 142 is utilized to control the cleaning solution valve switch (the pneumatic valve switches 120, 130) for introducing the cleaning solution into the coating device 102, the tanks 104, 106, and the pipes 146 for cleaning the whole coating apparatus 100. At this time, the control unit 142 can be utilized to close the pneumatic valve switches 116, 118 and 126 and the automatic pump 112, and to open the pneumatic valve switches 120, 122, 124, 128, 130, 132, 134 and 136, and then to activate the automatic pumps 108, 110 and 114 for introducing the cleaning solution into the coating device 102, the tanks 104, 106, and the pipes 146. Moreover, in the step S205, the control unit 142 is utilized to control the coating device 102 to continuously spray the cleaning solution, so as to clean the coating device 102.

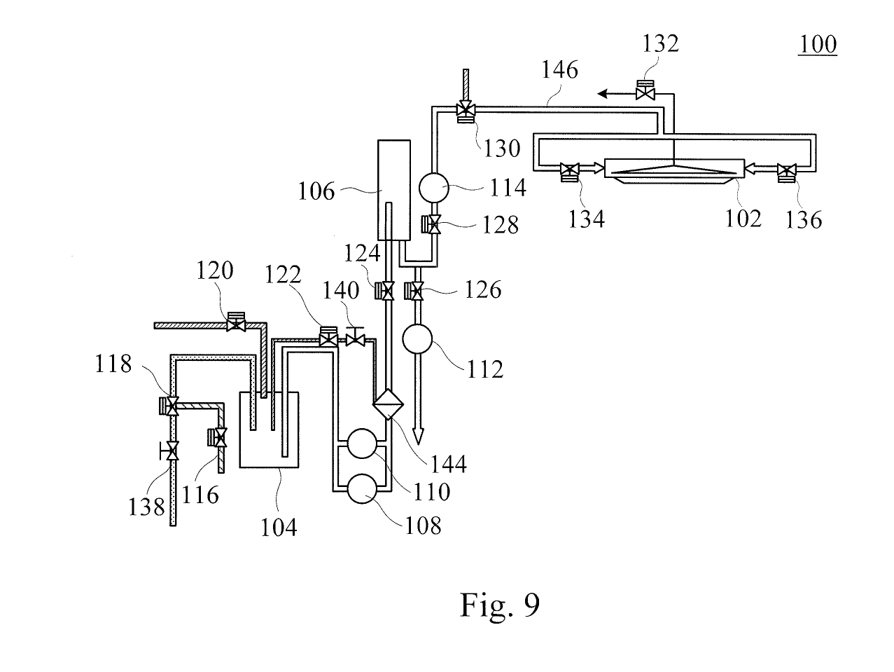

Referring to FIG. 3 and FIG. 9 again, in a step S206, the control unit 142 is utilized to control the draining device (automatic pump 112) for draining the cleaning solution from the coating device 102, the tanks 104, 106, and the pipes 146. At this time, the control unit 142 can be utilized to close the pneumatic valve switches 116, 118, 120 and 122 and the automatic pumps 108, 110 and 114, and to open the fifth to eleventh pneumatic valve switches 124-136, and then to activate the automatic pump 112 (the draining device) for draining the cleaning solution from the coating device 102, the tanks 104, 106, and the pipes 146.

It is worth mentioning that the cleaning process of the above-mentioned steps S205 and S206 can implemented for one time or several times to ensure the cleaning of the whole coating apparatus 100.

In one embodiment, the above-mentioned steps S203 and S204 can be omitted, and the above-mentioned steps S205 and S206 can be directly implemented for cleaning the coating device 102, the tanks 104, 106, and the pipes 146 at the same time. However, in other embodiments, the steps S205 and S206 can be also omitted but not limited to the above description.

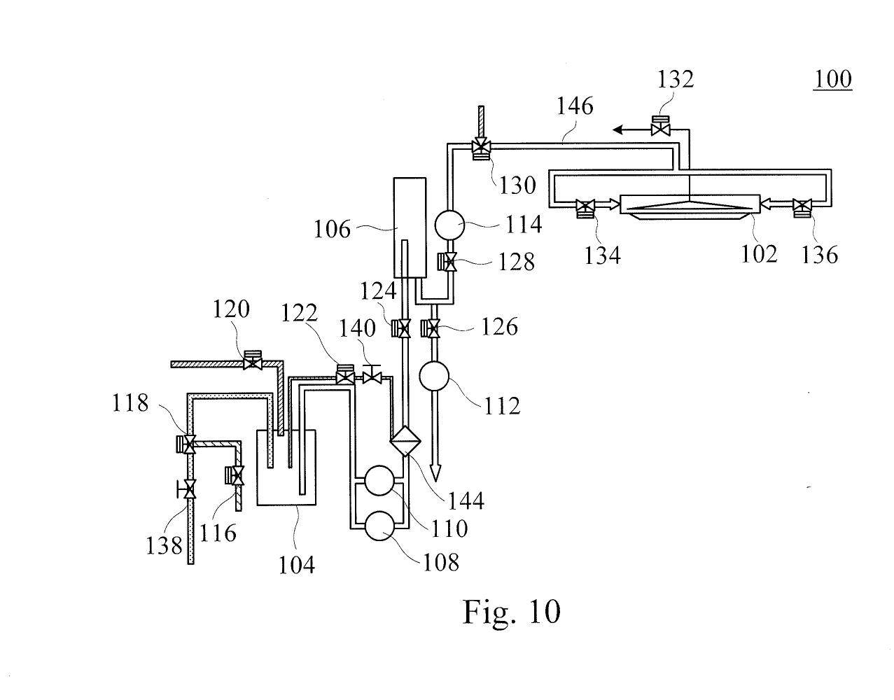

Referring to FIG. 3 and FIG. 10 again, in a step S207, the filter 144 is replaced by a new one, so as to prevent that the first liquid material or the cleaning solution is remained in the filter 144. At this time, the control unit 142 can be utilized to close the pneumatic valve switches 116-136 and the automatic pumps 108-114, and the filter 144 can be replaced manually.

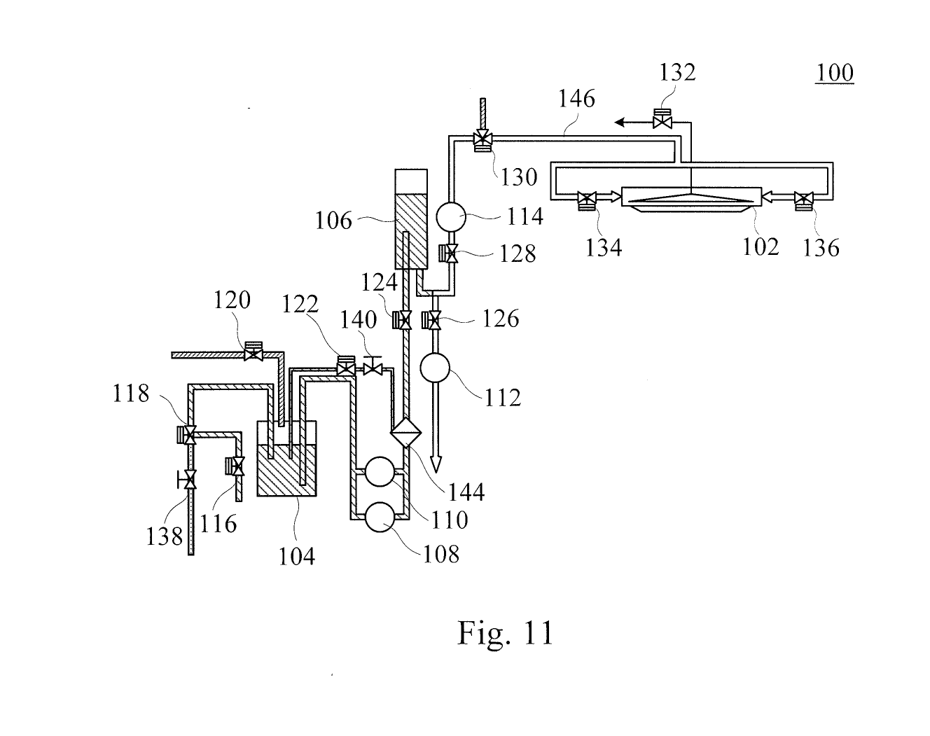

Referring to FIG. 3 and FIG. 11 again, in a step S208, the control unit 142 is utilized to control the second liquid material valve switch (the first pneumatic valve switch 116) for introducing the second liquid material into the tanks 104 and 106. At this time, the control unit 142 can be utilized to close the sixth to eleventh pneumatic valve switches 126-136 and the automatic pumps 112 and 114, and to open the first to fifth pneumatic valve switches 116-124, and then to activate the automatic pumps 108 and 110, so as to introduce the second liquid material into the tanks 104 and 106. In the step S208, the introduced second liquid material can react with the residual solution (the first liquid material or the cleaning solution) in the tanks 104 and 106. The second liquid material is stored in the tanks 104 and 106 after replacing the liquid material, i.e. the second liquid material is the new liquid material used by the coating apparatus 100, wherein the type of the second liquid material may be identically same or different to the first liquid material.

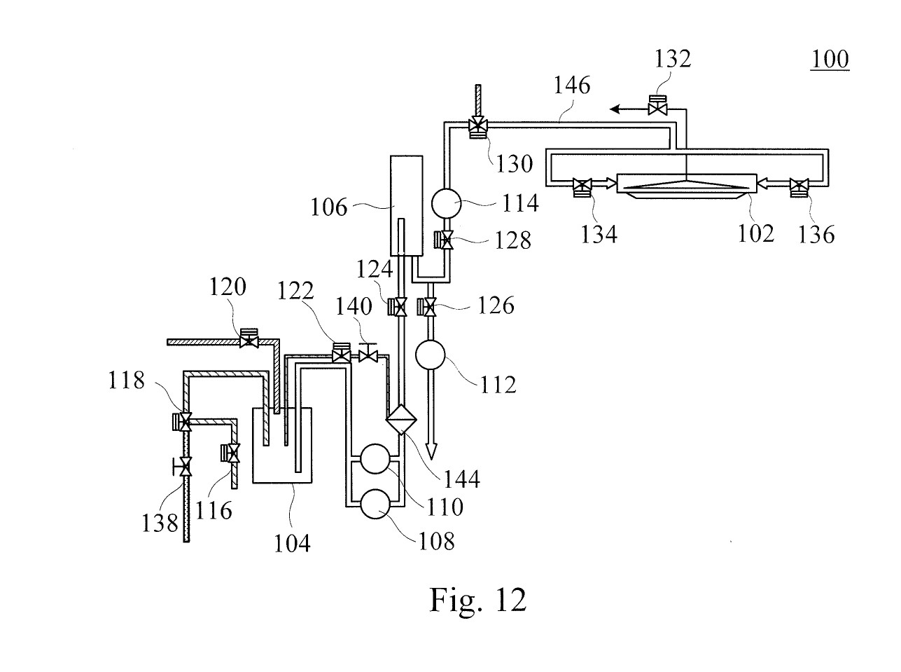

Referring to FIG. 3 and FIG. 12 again, in a step S209, the control unit 142 is utilized to control the draining device (automatic pump 112) for draining the second liquid material from the tanks 104 and 106. Therefore, the tanks 104, 106 can be cleaned by the second liquid material. At this time, the control unit 142 can be utilized to close the pneumatic valve switches 116, 118, 120, 122, 128, 130, 132, 134 and 136 and the automatic pump 114, and to open the fifth and sixth pneumatic valve switches 124 and 126, and then to activate the automatic pumps 108, 110 and 112 so as to drain the second liquid material from the tanks 104 and 106.

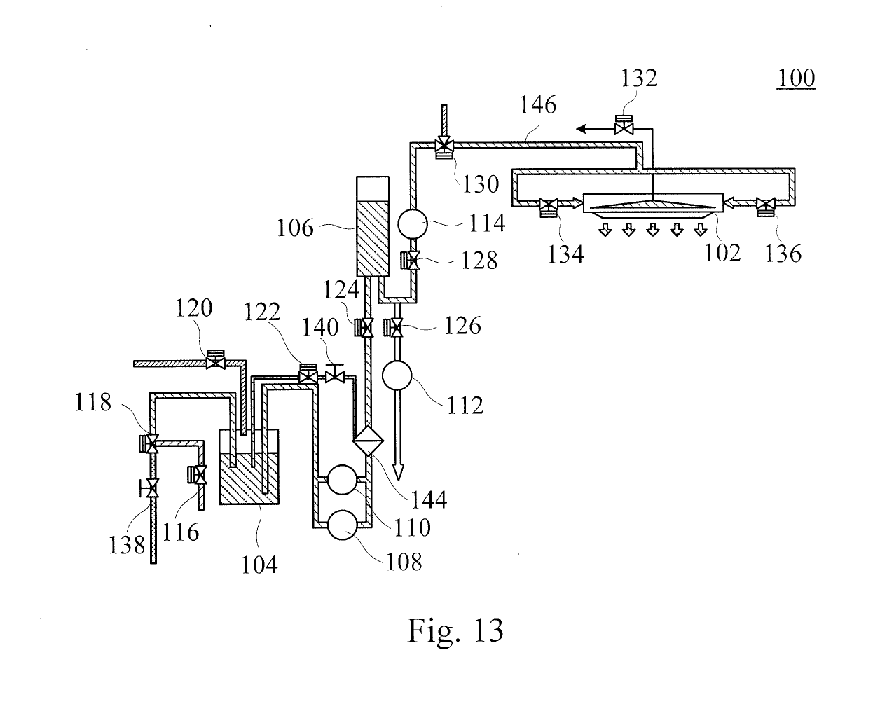

Referring to FIG. 3 and FIG. 13 again, in a step S210, the control unit 142 is utilized to control the second liquid material valve switch (the first pneumatic valve switch 116) for introducing the second liquid material into the coating device 102, the tanks 104, 106, and the pipes 146. Thus, the second liquid material can be introduced to clean the whole coating apparatus 100. Furthermore, in the step S210, with the use of the control unit 142, the coating device 102 can be controlled to continuously spray the second liquid material during a predetermined time, thereby cleaning the coating device 102. At this time, the control unit 142 can be utilized to close the pneumatic valve switches 120 and 126 and the automatic pump 112, and to open the pneumatic valve switches 116, 118, 122, 124, 128, 130, 132, 134 and 136, and then to activate the automatic pumps 108, 110 and 114 for introducing the second liquid material into the coating device 102, the tanks 104, 106, and the pipes 146.

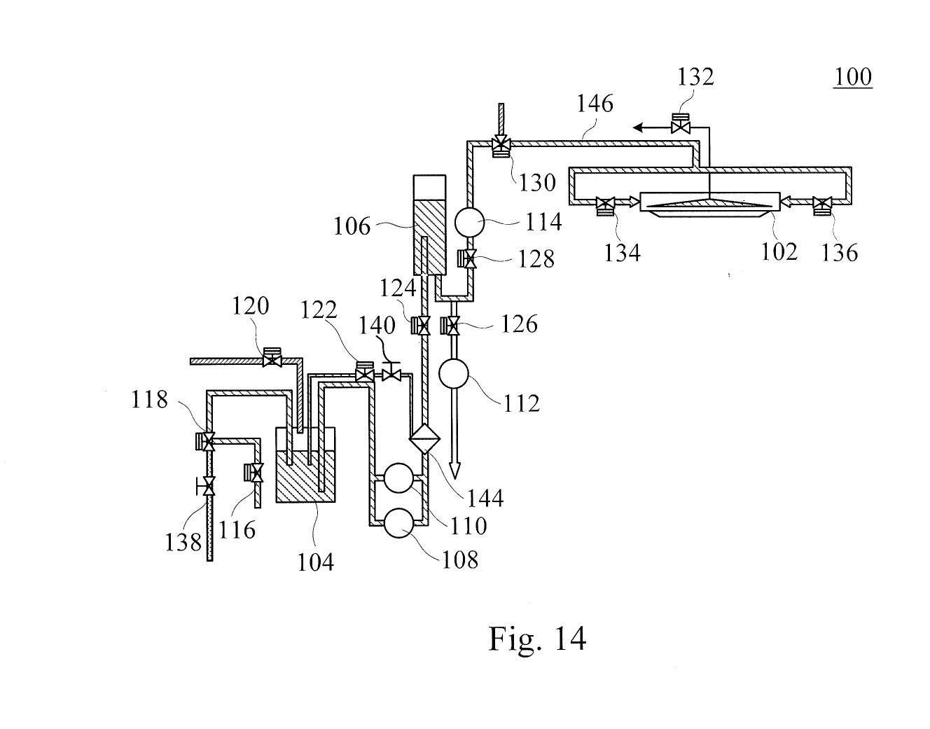

Referring to FIG. 3 and FIG. 14 again, in a step S211, the control unit 142 is utilized to control the coating device 102 for stopping the spray of the second liquid material, and then, for example, a clean wiper can be used to wipe the nozzle of the coating device 102 for preventing the residual of the solvent or foreign matter, and thus the liquid material of the coating apparatus 100 is replaced.

It is worth mentioning that the control unit 142 can control the implementing time and frequency of each device (the automatic pumps 108-114 and the pneumatic valve switches 116-136) according to the predetermined replacing procedure or instruction. That is, the implementing time (such as 5 minutes) or the number of times can be controlled by using the control unit 142 for ensuring the implement of each step. For example, by using the control unit 142, the draining time and frequency of the first liquid material, the introducing time and frequency and the draining time and frequency of the cleaning solution, and the draining time and frequency of the second liquid material can be controlled.

Therefore, when implementing the clean of the coating apparatus 100 and the replacement of the liquid material thereof, a user can input the predetermined procedure or instruction into the control unit 142 for allowing the control unit 142 to control the automatic pumps 108-114 and the pneumatic valve switches 116-136, and the cleaning of the coating apparatus 100 and the replacing of the liquid material thereof can be implemented automatically for automation, preventing the man-made errors and reducing the maintenance labor and time.

As described above, the coating apparatus, the method for replacing a liquid material thereof and the cleaning method thereof can automatically replace the liquid material, thereby preventing the man-made errors and reducing the maintenance labor and time. Furthermore, due to the automatic operation, the coating apparatus and the liquid material replacing method of the present invention can reduce the replacing time, thereby raising the throughput of the apparatus.

The present invention has been described with a preferred embodiment thereof and it is understood that many changes and modifications to the described embodiment can be carried out without departing from the scope and the spirit of the invention that is intended to be limited only by the appended claims.

1. A coating apparatus, comprising:
a coating device;
at least one tank connected to the coating device;
a draining device connected between the coating device and the tank and configured to drain a first liquid material and/or a cleaning solution;
a cleaning solution valve switch disposed between a cleaning solution tank and the tank and configured to switch the introduction of the cleaning solution;
a second liquid material valve switch disposed between a second liquid material tank and configured to switch the introduction of a second liquid material; and
a control unit electrically connected to the cleaning solution valve switch, the draining device and the second liquid material valve switch and configured to control the cleaning solution valve switch, the draining device and the second liquid material valve switch.

2. The coating apparatus according to claim 1, wherein the cleaning solution valve switch, the draining device and the second liquid material valve switch are controlled by the control unit according to a predetermined replacing procedure or instruction.

3. The coating apparatus according to claim 1, wherein the at least one tank comprises a first tank and a second tank, and the coating apparatus further comprises an automatic pump electrically connected between the first tank and the second tank.

4. The coating apparatus according to claim 3, further comprising a filter disposed between the first tank and the second tank.

5. The coating apparatus according to claim 1, wherein the coating apparatus further comprises an automatic pump connected between the draining device and the coating device.

6. A method for replacing a liquid material of a coating apparatus, wherein the coating apparatus comprises at least one tank, a draining device, a cleaning solution valve switch, a second liquid material valve switch and a control unit, and the draining device is configured to drain a first liquid material and/or a cleaning solution, and the cleaning solution valve switch is configured to switch the introduction of the cleaning solution, and the control unit is electrically connected to the cleaning solution valve switch, the draining device and the second liquid material valve switch, and the method comprises the following steps:
utilizing the control unit to control the draining device for draining the first liquid material from the tank;
utilizing the control unit to control the cleaning solution valve switch for introducing the cleaning solution into the tank;
utilizing the control unit to control the draining device for draining the cleaning solution from the tank; and
utilizing the control unit to control the second liquid material valve switch for introducing a second liquid material into the tank.

7. The method according to claim 6, wherein the coating apparatus further comprises a coating device, and the method further comprises the following step:
utilizing the control unit to control the draining device for draining the first liquid material from the coating device after draining the first liquid material from the tank.

8. The method according to claim 7, further comprising the following steps:
utilizing the control unit to control the cleaning solution valve switch for introducing the cleaning solution into the coating device and the tank after draining the cleaning solution from the tank and before introducing the second liquid material into the tank; and
utilizing the control unit to control the draining device for draining the cleaning solution from the coating device and the tank.

9. The method according to claim 7, further comprising the following steps:
utilizing the control unit to control the draining device for draining the second liquid material from the tank; and
utilizing the control unit to control the second liquid material valve switch for introducing the second liquid material into the coating device and the tank.

10. The method according to claim 9, further comprising the following steps:
utilizing the control unit to control the coating device for continuously spraying the second liquid material during a predetermined time; and
utilizing the control unit to control the coating device for stopping the spray of the second liquid material.

11. A cleaning method of a coating apparatus, wherein the coating apparatus comprises at least one tank, a draining device, a cleaning solution valve switch, a second liquid material valve switch and a control unit, and the draining device is configured to drain a first liquid material and/or a cleaning solution, and the cleaning solution valve switch is configured to switch the introduction of the cleaning solution, and the control unit is electrically connected to the cleaning solution valve switch, the draining device and the second liquid material valve switch, and the method comprises the following steps:
utilizing the control unit to control the draining device for draining the first liquid material from the tank;
utilizing the control unit to control the cleaning solution valve switch for introducing the cleaning solution into the tank; and
utilizing the control unit to control the draining device for draining the cleaning solution from the tank.

12. The method according to claim 11, wherein the coating apparatus further comprises a coating device, and the method further comprises the following step:
utilizing the control unit to control the draining device for draining the first liquid material from the coating device after draining the first liquid material from the tank.

13. The method according to claim 12, further comprising the following steps:
utilizing the control unit to control the cleaning solution valve switch for introducing the cleaning solution into the coating device and the tank after draining the cleaning solution from the tank; and
utilizing the control unit to control the draining device for draining the cleaning solution from the coating device and the tank.
